(19) United States
(12) Patent Application Publication
(10) Pub. No.: US 2010/0299652 A1
(43) Pub. Date: Nov. 25, 2010

(54) APPARATUS AND METHOD FOR MANAGING COMPONENTS IN SCA SYSTEM

(75) Inventors: Chan Yong Lee, Daejeon (KR); Nam Hoon Park, Daejeon (KR)

Correspondence Address: LAHIVE & COCKFIELD, LLP;FLOOR 30, SUITE 3000, ONE POST OFFICE SQUARE, BOSTON, MA, 02109, US

(73) Assignee: Electronics and Telecommunications Research Institute, Daejeon (KR)

(21) Appl. No.: 12/446,094

(22) PCT Filed: Oct. 5, 2007
(86) PCT No.: PCT/KR07/04864

§ 371 Date: Apr. 17, 2009

(30) Foreign Application Priority Data
Nov. 7, 2006 (KR) 10-2006-0109432

(51) Int. Cl. G06F 9/44

(52) U.S. Cl. 717/120

(57) ABSTRACT

An apparatus for managing components in an SCA system includes a naming context tree having one or more directories. Each directory has an ID, the ID is assigned to a component to be registered, and the component is registered in the directory having the ID and unregistered from the directory. The apparatus further includes a name server for managing the components registered in the directories of the naming context tree.

### TECHNICAL FIELD

The present invention relates to a software communication architecture (SCA) system, and more particularly, to an apparatus and a method for managing components in an SCA system wherein the components are registered or unregistered by directories.

This work was supported by the IT R&D program of MIC/IITA. [2006-S-012-01, Apparatus and Method of Management for Reusable Component]

### BACKGROUND ART

A software communication architecture (SCA) system is a communication software structure, proposed by the Joint Tactical Radio System (JTRS) Joint Program Office(JPO), which was established for developing communication systems, to greatly improve interoperability between communication systems and reduce development and arrangement cost. In the software communication architecture (SCA) system, the Common Object Request Broker Architecture (CORBA) that is an industrial standard of a distributed object model is adopted as middleware to provide an environment suitable for different types of hardware and software. This is not a standard limited to a particular system but an independent system design framework.

At present, the SCA system utilizes a domain manager and a device manager to manage (e.g., register or unregister) device, service and application components, and also utilizes a name server to rebind and unbind the components. Specifically, the registration and unregistration are performed on respective domain manager, device manager, device, service, and application components.

FIG. 1 is a diagram of components registered in a name server of a SCA system according to a prior art.

The constitution of the components registered in the name server of a conventional SCA system is described as follows.

The components registered in a name server 10 include a device manager component(s) 12 for managing device(s) and service(s) in domain(s), domain manager component(s) 14 for managing the domain(s), application component(s) 16 corresponding to application(s), device component(s) 18 corresponding to the device(s), and service component(s) 19 corresponding to the service(s). The components, when running, are registered in the name server 10.

FIGS. 2 to 4 are flowcharts illustrating a procedure of registering the components in the name server 10 of the SCA system according to a prior art.

In FIG. 2, a procedure of registering a domain manager component 14, is shown. First, the domain manager component 14 is generally run by a user or another application program upon boot up, so that the domain manager component 14 is registered in a node (S10).

Next, by parsing an XML file through a Domain Manger configuration Descriptor (DMD), which is received as an execution parameter, the related service information is obtained (S12).

Finally, the domain manager component 14 is registered in the name server (S14).

In FIG. 3, a procedure of registering the device manager, device, and service components 12, 18, and 19 is shown.

A Device Configuration Descriptor (DCD) file is used to register the above components. The DCD file basically includes information on the device manager component 12, but may not include information on the device, service and domain manager components 18, 19, and 14 managed by the device manager. If the information on the device, service, and domain manager components 18, 19, and 14 is included, by parsing Software Package Descriptor (SPD), Software component Descriptor (SCD), and Properties Descriptor (PRF) files, which are related to the device manager component 12 of DCD file and are included in the XML file, the device manager component 12 is loaded and executed (S20).

The executed device manager component 12 then loads and executes all the device and service components in the DCD file.

The executed components register in the device manager component 12, that the components have been executed (S24)

Thereafter, the device manager component 12 registers itself and device and service components 18, 19 managed by the device manager component 12 in the domain manager component (S26). Here, the device or service component 18, 19 in the DCD file may be arranged on a current node or a specific device. In the former case, the device or service component is arranged by loading and executing through the device manager component 12. In the latter case, the device manager component 12 executes a specific component, and then the specific component loads or executes the device or service component to arrange it.

All the executed device and service components inform, that they have been registered, to the device manager component 12, and they rebind themselves in the name server, and also the device manager component 12 rebinds itself in the name server (S28 and S30).

In FIG. 4, a procedure of registering the application component 16 is shown. In this procedure, a specific type of application is created by an application factory to achieve the registration. More specifically, first, one application is selected from a displayed list of the application factory, and an instance name for the selected application is input (S40). One instance is then created with the application name (S42).

A list of application components 16 to be launched is received via a software assembly descriptor (SAD) file in the XML (S44).

An execution file of each application component 16 is run on an executable device adapted to execute the application component (S46).

The application component 16 is registered in the domain manager and the application component 16 registers itself in the name server 10 (S48).

FIGS. 5 to 7 are flowcharts illustrating a procedure of unregistering components from the name server of the SCA system according to a prior art.

In FIG. 5, a procedure of unregistering the domain manager component 14 is shown.

First, the name server 10 receives a command to unregister the domain manager component 14 on the node (S50).

A resource of the domain manager component 14 is unregistered (S52).

The domain manager component 14 is then unregistered from the name server 10, and is terminated (S54).

In FIG. 6, a procedure of unregistering the device manager, device, and service components 12, 18, and 19 is shown. The procedure includes a process of unregistering the device manager component 12 except components managed by the device manager, and a process of unregistering device manager components 12 including the components managed by the device manager.

When a command to unregister the device manager component and the components managed by the device manager component is received (S60), the device and service components 18, 19 managed by the device manager are terminated (S62).

Thereafter, the device manager requests the domain manager component to unregister the device manager, and the device and service components 12, 18, and 19 (S64).

Information on the device manager component 12, and the device and service components 18, 19 is removed from the name server 10, the components to be unregistered are removed from an Operating System (OS) (S66), and then the device manager component 12 terminates itself (S68).

In FIG. 7, a procedure of unregistering an application component 16 is shown.

First, the name server receives a command to unregister the application component 16 (S70).

The domain manager component 14 unregisters the application component 16 (S72), the name server 10 rebinds the application component 16, and the component to be unregistered is removed from an Operating System (OS) (S74).

However, in the conventional method for registering or unregistering the device, service and application components 18, 19, and 16 in the SCA system, both the device manager component and the domain manager component need to manage information on the device, service, application component 18, 19, and 16, and the name server 10 also needs to rebind and unbind the components. Accordingly, lots of resources are wasted for component management.

Moreover, when an abnormal error is generated in the SCA system, complexity of component management occurs due to a discrepancy of component information currently registered and used in the device manager, the domain manager, and the name server.

### DISCLOSURE OF INVENTION

### Technical Problem

It is, therefore, an object of the present invention to provide an apparatus and a method for managing components in an SCA system in a directory scheme of tree form.

Another object of the present invention is to provide an apparatus and a method for managing components in an SCA system by enabling a name server to collectively manage the components and information thereof, which is capable of simplifying registration and unregistration mechanism and preventing discrepancy in registered components.

### Technical Solution

In accordance with an aspect of the present invention, there is provided an apparatus for managing components in a software communication architecture (SCA) system, the apparatus comprising:

a naming context tree having one or more directories, each directory having an ID, the ID being assigned to a component to be registered, and the component being registered in the directory having the ID and unregistered from the directory; and

a name server for managing the component registered in the directory of the naming context tree.

In accordance with another aspect of the present invention, there is provided a method for registering components in an SCA system having a naming context tree having one or more directories, the respective directories having an ID, the method comprising the steps of:

assigning the ID to a component to be registered;

determining whether the directory having to the ID assigned to the component exists in the name server; and

creating a directory for the component on the naming context tree when the directory does not exist; and

registering the component in the created directory or an existing directory when the directory exists.

In accordance with further another aspect of the present invention, there is provided a method for unregistering components in an SCA system, each component being registered in a predefined directory of a naming context tree, the method comprising the steps of:

receiving a command to unregister the component; and

unregistering the component from the directory at which the component is registered.

### ADVANTAGEOUS EFFECTS

Therefore, according to the method as described above, when it is required to register a component, the component is registered in a directory of naming context tree having an ID assigned to the component. In contrast, when it is required to unregister the component registered in the directory, the component is unregistered from the directory of the naming context tree. This can prevent discrepancy in components to be registered/unregistered between the device manager and domain manager components and the name server and minimize the use of component resources of the device manager. Thus, it is possible to simplify a registration and unregistration mechanism and avoid the discrepancy in registered components.

Further, the name server manages the device and service component information that has been managed by the device manager component and the components that have been managed by the domain manager, thereby reducing overlapped component resources and maintaining consistency of the management.

### BRIEF DESCRIPTION OF THE DRAWINGS

The above and other objects and features of the present invention will become apparent from the following description of embodiments given in conjunction with the accompanying drawings, in which:

FIG. 1 is a diagram of components registered in a name server of an SCA system according to a prior art;

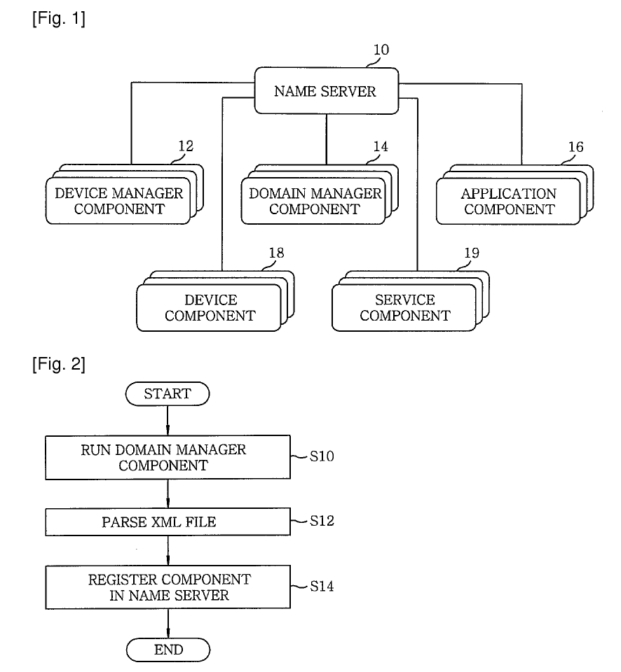

FIGS. 2 to 4 are flowcharts illustrating a procedure of registering components in a name server of an SCA system according to a prior art;

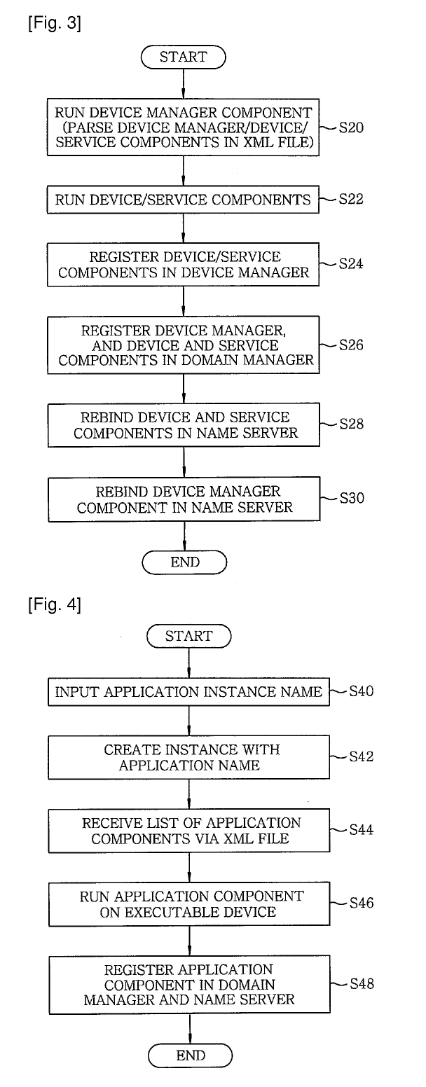

FIGS. 5 to 7 are flowcharts illustrating a procedure of unregistering components in a name server of an SCA system according to a prior art;

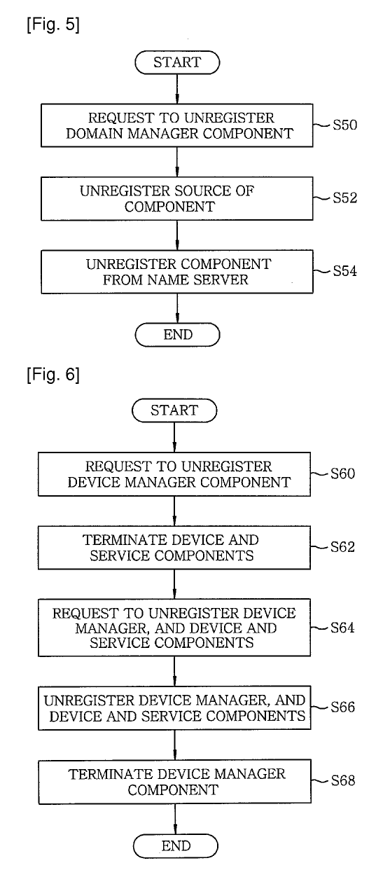

FIG. 8 illustrates an apparatus for managing components registered in a name server of an SCA system according to the present invention;

FIG. 9 illustrates a structure of an XML file defining the directory of the naming context tree to manage components registered in a name server of an SCA system according to the present invention;

FIG. 10 is a flowchart illustrating a procedure of registering components in a name server of an SCA system according to the present invention; and

FIG. 11 is a flowchart illustrating a procedure of unregistering components in a name server of an SCA system according to the present invention.

### BEST MODE FOR CARRYING OUT THE INVENTION

Hereinafter, embodiments of the present invention will be described in detail with reference to the accompanying drawings so that they can be readily implemented by those skilled in the art.

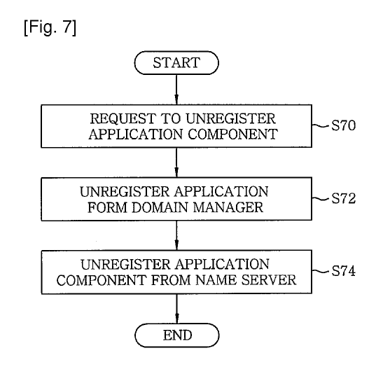

FIG. 8 illustrates an apparatus for managing components registered in a name server of an SCA system in accordance with the present invention.

The apparatus for managing a plurality of components in an SCA system includes a name server 100 and a naming context tree 110 where each of the components is hierarchically located at a directory by the name server 12.

The components includes a domain manager component (hereinafter refers to as DMC) 112 for managing one or more domains in the SCA system, a device manager component (hereinafter refers to as DEMC) 114, 116 for managing devices and services in the domain, a device component (hereinafter refers to as DC) for managing devices, a service component (hereinafter refers to as SC) 118 for managing services, and an application component (hereinafter refers to as AC) 1140a, 1140b for managing applications in the SCA system. Here, the components may be implemented with software program that can be arranged and replaced.

The name server 100 registers the DMC 112; the DEMCs 114, 116; the DCs 1140, 1142; the SC 118; and the ACs 1140a, 1140b in a directory in a naming context tree 110 when the components are run.

The name server 100 unregisters the DMC 112, the DEMC 114, 116, the DC 1140, 1142, the SC 118 or the AC 1140a, 1140b from the directory in the naming context tree 110 where the component is located when there is a request to unregister the component or the components. The naming context tree 110 includes an upper directory ‘A’ where the DMC 112 is registered/unregistered. The upper directory ‘A’ for the DMC 112 includes three subdirectories ‘A/A’, ‘A/B’ and ‘A/C’ where the DEMCs 114, 116 and the SC 118 are registered/unregistered, respectively. A first subdirectory, e.g., ‘A/A’ for the DMC 114, includes two subdirectories ‘A/A/A and A/A/B’ where the DCs 1140 and 1142 are registered/unregistered, respectively, in parallel. A first subdirectory, e.g., ‘A/A/A’ for the DC 1140 includes two subdirectories ‘A/A/A/A’ and ‘A/A/A/B’ where the ACs 1140a and 1140b are registered/unregistered, respectively. A second subdirectory ‘A/A/B’ for the DC 1142 includes a subdirectory ‘A/A/B/A’ where the DC 1142a is registered/unregistered.

Although the upper directory and the subdirectories have been illustrated and disclosed to have one to three in FIG. 8, those skilled person in the art may be recognized that the number of the directories in the naming context tree can be newly added as will be described and the naming context tree can be modified to have other types of directory schemes.

According to the apparatus of the present invention, the name server 100 utilizes the directories of the naming context tree created in advance prior to registering the device, service and application components, and the device manager and domain manager components or the name sever 100 newly creates the directories for the above components if there are no directories at the time of registering the components.

Also, the name server 100 removes or remains a directory of the naming context tree at the time of unregistering a component.

Further, the name server 100 may recognize a correlation among the components since the name server 100 manages the components located in the directories of the naming context tree.

In order to locate the components in the corresponding directories, a name or ID is defined in an XML file, which indicates a site, i.e., a directory in the naming context tree where a component resides and runs. Upon registering or unregistering, the ID is assigned to the component. Thus, the name server 100 finds the directory having the ID assigned to the component and registers/unregisters the component in and from the directory having the ID.

Accordingly, the apparatus according to the present invention manages the device component, the service component and the application component registered in the directory of the naming context tree 110. Thus, the device manager and domain manager components do not have to separately manage the device, service and application components, thereby minimizing the use of component resources and preventing discrepancy in components to be registered/unregistered between the device manager and domain manager components and the name server.

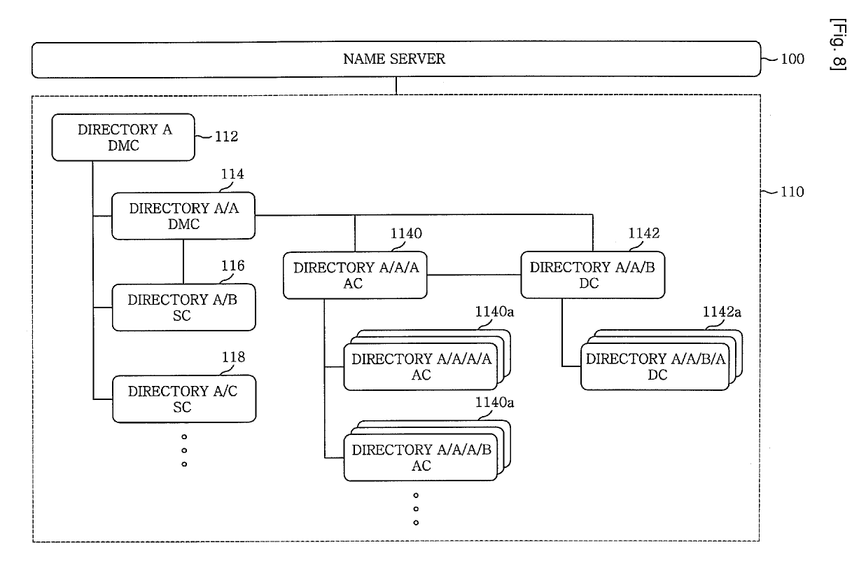

FIG. 9 illustrates an XML file defining a directory scheme of the naming context tree to manage components registered in the name server of a SCA system according to the present invention.

In FIG. 9, the directories (e.g., ‘A’, ‘A/A’, etc.) of the naming context tree, where components are located, are defined in “name” (e.g., 31, 311, 3111, 31111, 31112, 3112, 31121, 312, 313, and 32), and codes (e.g., “0”, “00”, etc) corresponding to the directories of the naming context tree are defined in “id” (e.g., 31, 311, 3111, 31111, 31112, 3112, 31121, 312, 313, and 32) so that the components easily recognize the domain names.

That is, the XML file defines the directories of the naming context tree indicating categories to which the device component, the service component and the application component belong and in which the components are executed, thereby achieving the assignment of corresponding components in the directories of the naming context tree. Accordingly, all components are identified the “ids” by which the components are registered and unregistered in and from the corresponding directories of the naming context tree, such that the name server can manage the components systematically.

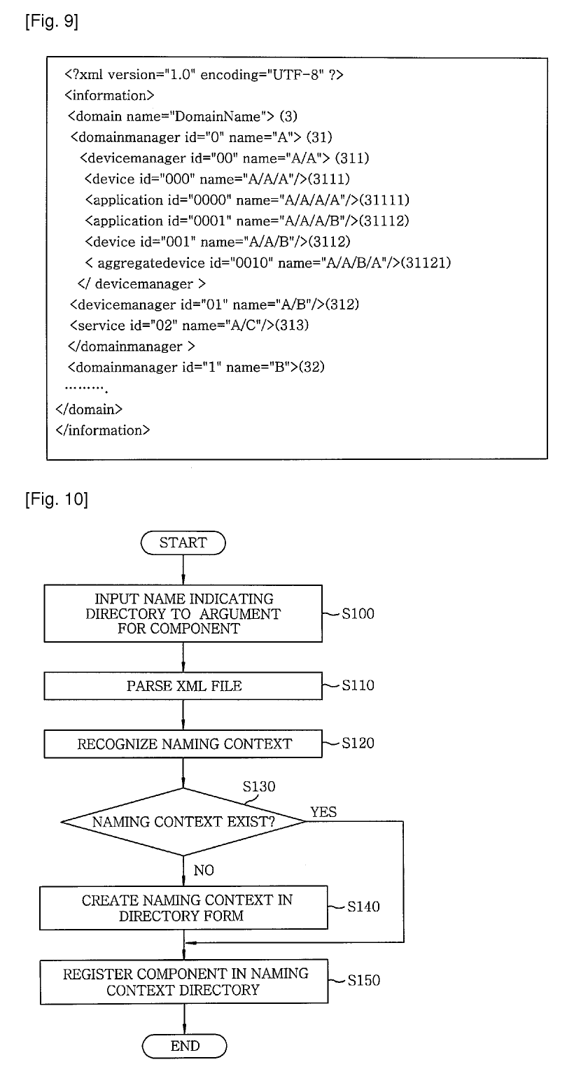

FIG. 10 is a flowchart illustrating a procedure of registering components in the name server of the SCA system in accordance with the present invention.

A method for registering components in the name server of the SCA system will now be described with reference to FIGS. 8 and 10.

An ID indicating the directory of the naming context tree 110 is assigned to an argument for a component to be registered and the component runs (S100).

The component, which has already run, parses the XML file (S110).

The component recognizes the scheme of the naming context tree (S120).

The component determines whether a directory of the naming context tree 110 corresponding to the ID exists or not (S130).

If it is determined in S130 that the directory corresponding to the ID does not exist, a naming context for the ID is created in a form of a directory on the naming context tree 110 (S140).

The name server 100 then registers the component in the directory the naming context (S150).

However, if it is determined in S130 that the directory for the ID exists, the name server 100 registers the component in the directory of the naming context tree 110, as in step S150.

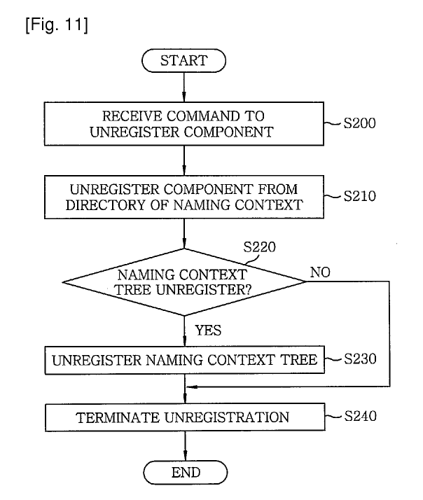

FIG. 11 is a flowchart illustrating a procedure of unregistering the components in the name server of the SCA system in accordance with the present invention.

A method of unregistering components in the name server of the SCA system will now be described with reference to FIGS. 8 and 11.

First, when it is required to unregister a component, the component registered in a corresponding directory receives a command to unregister the component (S200).

The component then unregisters from a directory thereof in the naming context tree (S210).

Next, the name server 100 determines whether to unregister the directory of the naming context tree 110 in which the component was unregistered (S220).

If it is determined in S220 that the directory of the naming context tree is to be unregistered, the name server unregisters the directory of the naming context tree 110 (S230) and then terminates component unregistration (S240).

However, if it is determined in S220 that the directory of the naming context tree is not to be unregistered, the name server terminates the component unregistration, as in step S240.

While the invention has been shown and described with respect to the preferred embodiments, it will be understood by those skilled in the art that various changes and modifications may be made without departing from the spirit and scope of the invention as defined in the following claims.

1. An apparatus for managing components in a software communication architecture (SCA) system, the apparatus comprising:
a naming context tree having one or more directories, each directory having an ID, the ID being assigned to a component to be registered, and the component being registered in the directory having the ID and unregistered from the directory; and
a name server for managing the component registered in the directory of the naming context tree.

2. The apparatus of claim 1, wherein the name server manages the components based on the categories for the components.

3. The apparatus of claim 2, wherein the components includes:
a domain manager component for managing a domain;
a device manager component for managing devices and services;
a device component for managing the devices;
a service component for managing the services; and
an application component for managing applications,
wherein the domain manager component is registered in an upper directory in the naming context tree, and the other components is registered in subdirectories of the upper directory.

4. The apparatus of claim 1, wherein the name server creates the directory prior to registering the component or at the time of registering the component.

5. The apparatus of claim 1, wherein the name server removes or remains the directory where the component is registered upon unregistering the component.

6. The apparatus of claim 1, wherein a directory scheme of the naming context tree is defined in an XML file in the name server.

7. A method for registering components in an SCA system having a naming context tree having one or more directories, the respective directories having an ID, the method comprising the steps of:
assigning the ID to a component to be registered;
determining whether the directory having to the ID assigned to the component exists in the name server;
creating a directory for the component on the naming context tree when the directory does not exist; and
registering the component in the created directory or an existing directory when the directory exists.

8. The method of claim 7, wherein a directory scheme of the naming context tree is defined in an XML file, and
the method further comprising the step of parsing the XML file in the component to determine the presence of the directory.

9. A method for unregistering components in an SCA system, each component being registered in a predefined directory of a naming context tree, the method comprising the steps of:
receiving a command to unregister the component; and
unregistering the component from the directory at which the component is registered.

10. The method of claim 9, further comprising:
after unregistering the component, determining whether to unregister the directory of the naming context tree from which the component has been un registered; and
terminating the component unregistration after the unregisteration of the directory when it is determined that the directory is to be unregistered, and terminating the component unregisteration when it is determined that the directory is not to be unregistered.
